(19) United States
(12) Patent Application Publication
(10) Pub. No.: US 2004/0216652 A1
(43) Pub. Date: Nov. 4, 2004

(54) Protection device for buildings or installation

(76) Inventor: Egon Evertz, Solingen (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/250,778

(22) PCT Filed: Feb. 14, 2002
(86) PCT No.: PCT/DE02/00544

(30) Foreign Application Priority Data
Nov. 8, 2001 (DE) 101 54 487.1
Nov. 12, 2001 (DE) 101 55 174.6

(51) Int. Cl. E06B 9/00

(52) U.S. Cl. 109/49.5

(57) ABSTRACT

The invention relates to a device for protecting buildings or constructions against outer influences, whereby at least around one part of the building or construction wire ropes are stretched.

The invention relates to a device for protecting buildings or constructions against outside influences.

Already DE 43 21 229 A1 points out that industrial constructions must be protected against outside or inside influences. Among others, for outside influences there are mentioned natural disasters as earth quakes, flooding or fire, train or air-plane crashes or other explosions. As proposed in DE 43 21 229 A1 an industrial construction can be protected with relevant technical safety components arranged in an outer covering that consists of a basic ground and hereon mounted circular cylinder or truncated cone and a shell element put thereon that covers the mentioned circular cylinder or truncated cone. The outer covering should be namely of steel concrete. Such a safety device is planned for chemical construction buildings with highly toxic and explosive elements of the primary cycle of a nuclear power station, whereby the protective construction parts have to be arranged in an allround closed steel concrete covering. The steel concrete covering has to be that way to put enough resistance against a crashing airplane.

As the terror attacks on Sep. 11^{th}, 2001 on the World Trade Center as well as on an US-government office show, there is a great need to protect those buildings and the people working therein. Beside that the housing of the building or construction to be protected is a relatively great expense, there is also the disadvantage that inside the protective covering people can just work with artificial lighting which should be avoided seen from working-psychological reasons.

It is therefor an object of the present invention to build a safety device for buildings or constructions against outer influences whereby the chosen shape of the building is optically possibly kept that way and also the safety device can be build up without great technical effort and that the natural rays of light are—at least as far as possible—not interfered.

For achieving this object according to the invention there is proposed that at least around a part of the building or the construction there are wire ropes stretched. Wire ropes have the effect of cutting tools to the airplane or airplane parts that are piloted into buildings or that even result from airplane crashes. Wire ropes intercept a great part of the kinetic energy of the impacting airplane body which is thereby already partly damaged or destructed. The impact of the plane into the wire ropes lead to an unavoidable explosion which takes place earlier and with a distance to the building so that less power of the impact reaches the building. The stretched ropes can not avoid parts of the plane hitting the building but the damage thereby is much less regarding the damage that would emerge from a plane crashing right into the building or construction wherein an unavoidable explosion would have an disastrous effect. The formation of the ropes, in particular the distance of each rope to the other, the distance to the building and their strength can be adapted to the respective desired protection respectively the acceptable effort for possible making-up building-work on a building.

Further embodiments of the invention are describe in the sub claims. So there are arranged at least a few ropes above the building or the construction, preferably at a distance of 10 m. The most effective protection of a building is given when the distance of the respective ropes to the building is relatively great. However, this is essentially on the whole depending on the height of the protective building as well as the space around needed for the necessary stretching of the wire ropes. In less or no density of population there can be reached distances of the guy-ropes of 100 m referring to the height of the respective mast on which the stretched ropes are mounted. Such guy-ropes are known in principle by transmitting masts whereby the rope respectively ropes are lead from the mast to the ground where they are mounted and having an angle of 45° or less. In the simplest case the guy-ropes are connected with single masts that are on or beside the building to be protected. The wire ropes can be alternatively or additionally be stretched between additional support columns. On buildings with several towers it is possible to stretch the ropes between the towers. It is also possible on high towers to stretch wire ropes between carriers protruding horizontally of the tower. For greater protection of a building it is possible to build a protective covering of wire ropes and the respective support columns being carried by itself and building a coarse network. The distance of parallel wire ropes to each other can be respective to the span of airplane wings between 5 m and 15 m, preferably 10 m. In essence it is just important that the greatest “mesh width” of such a network is smaller than the span of airplane wings so that the building is protected against an unhindered crash. An already acceptable protection can be reached by steel wire ropes with a diameter of at least 0,5 cm. Thinner ropes have the disadvantage of less tensile strength but being essentially more effective in “cutting”. Therefor thick ropes have the advantage of a higher tensile strength. For choosing the material of the ropes or how to build up the ropes can be referred to the knowledge of how the stretched ropes are used at transmitting masts.

It is according to a further embodiment of the invention possible to increase the protective effect by wave-grounding on the upper surface of the ropes a wavy as it is known for example from bread or all-purpose-knives. The wavy-grind is earliest optimized when the wire ropes not round in its diameter but oval, like knives or leave-shaped. In this case the cutting effect is highly increased.

Within the framework of the present invention it is also possible to arrange flexible bodies, respectively coil springs, in the region of the guy-ropes. These springs increase the elasticity of the rope to reach a cutting effect, so that by crashing of a plane the rope is extended to the maximum stretching before it is ripped up or the spring is teared up.

Further advantages and embodiments for the safety device according to the invention are shown in the drawings. Therein

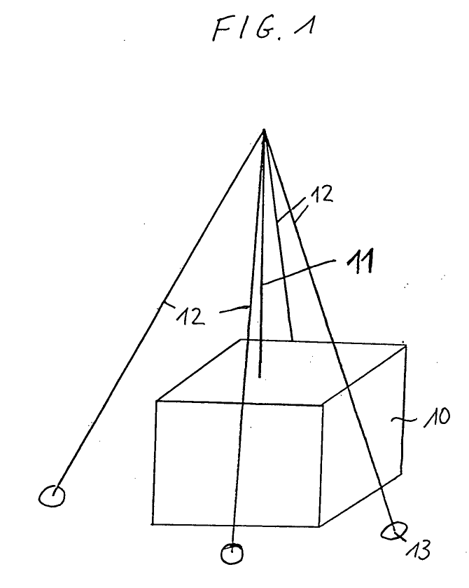

FIG. 1 to 3 show principle representations of buildings 10, shown here as a cube respectively square, each being protected by wire ropes.

According to FIG. 1 a mast 11 is mounted on the roof of the building that should have a great height. From this mast 11 several ropes 12 are stretched and mounted to the concrete ground 13. There can be used more the four ropes 12 according to the size of the building or the height of the mast.

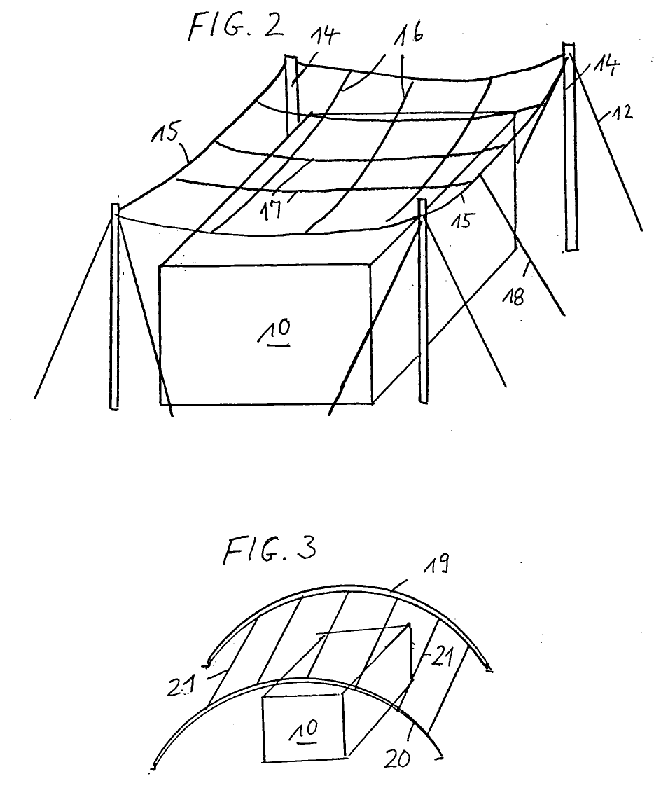

In an alternative embodiment according to FIG. 2 there are shown four carriers 14 beside the building that are connected through stretched ropes 12 and between them additional ropes 15 are stretched, thereto running additional longitudinal as well as traverse ropes 16 and 17—here crosswise. If necessary, there can be arranged additional stretching-ropes 18 that are mounted to the ground. Surely, there can be used more than four carrier. According to an embodiment of the invention the wire ropes 15 and 16 can be mounted loosely so that in case of an airplane crash there is no danger that these ropes are ripped up earlier because they were stretched.

According to FIG. 3 there are two (or more) steel profiles 19 and 20 formed as ground between that distance several ropes 21 are stretched or according to ropes 15 and 16 are mounted loosely. This self-carrying construction “bridges” the building 10, whereby between the ropes 21 and the roof of the building should be an at least greatest distance. If necessary additional ropes can be stretched over a mast mounted on the roof of the building according to FIG. 1 so that a greater protection is possible.

Ropes 12, 15, 16, 17 and/or 21 can also be connected by an intermediate piece or by respective steel-spring screws on their ends whereby the elasticity of the rope construction is increased. A cutting-through or ripping-up of the tightly stretched ropes by an airplane crash is therewith avoided, respectively considerable delayed. With increasing of the elasticity also the “sawing-effect” increases that is put on the airplane parts by the ropes.

The greater the distance of the ropes to the protective building or chemical construction is and the more stabilized against ripping up of the ropes 12, 15, 16, 17 and/or 21 are, the more probable is the cushion of the crashing or target-piloted airplane as well as its destruction. There is no way indeed to avoid that airplane parts crash onto the building 10 but the power of impact is considerably decreased. Beyond that any threatening explosions are shifted outside the protective building 10.

Above all, by the chosen construction there is namely a protection for nuclear power stations that can also be combined with the covering according to DE 43 21 229 A1. As far as there is already an existing steel covering and additionally a wire-rope stretching is planned, there is an obviously better building protection whereby it is unlikely that the protective construction parts will be damaged.

1. Device for protection of buildings or constructions against outer influences characterized in that around at least one part of the building or the construction wire ropes are stretched.

2. Device according to claim 1, characterized in that at least some of the wire ropes are above the building or the construction, preferably at a distance of 10 m or more.

3. Device according to claim 1, characterized in that wire ropes stretch between single masts that are mounted on the protective building or construction or beside thereto.

4. Device according to claim 1, characterized in that the wire ropes are stretched between columns or that the whole of the wire ropes and the columns builds up a self-carrying protective covering.

5. Device according to claim 1, characterized in that the distance of wire ropes parallel to each other is 5 m to 15 m, preferably about 10 m.

6. Device according to claim 1, characterized in that the diameter of the wire rope is at least 0,5 cm.

7. Device according to claim 1, characterized in that the wire ropes are connected with flexible bodies, preferably spring screws.

8. Device according to claim 1, characterized in that the wire ropes a, e (knife-) blade-shaped.

9. Device according to claim 8, characterized in that the blade-shaped wire ropes have a wave-grounding.
